(19) United States
(12) Patent Application Publication
(10) Pub. No.: US 2026/0318598 A1
(43) Pub. Date: Oct. 15, 2026

(54) BLOWER NOZZLE ASSEMBLY AND SYSTEMS AND METHODS THEREOF

(71) Applicant: Sonny's HFI Holdings, LLC, Wilmington, DE (US)

(72) Inventor: Sidney Charles Brod, Boca Raton, FL (US)

(21) Appl. No.: 19/641,874

(22) Filed: Apr. 8, 2026

Related U.S. Application Data
(60) Provisional application No. 63/787,265, filed on Apr. 11, 2025.

(51) Int. Cl. F26B 21/00

(52) U.S. Cl. CPC F26B 21/001

(57) ABSTRACT

An adjustable nozzle for delivering forced air to vehicles includes a stationary housing with a spherical surface; a first tubular nozzle shell received by the housing and shaped as a bilaterally truncated sphere; and a second tubular nozzle shell received by the first shell with a nozzle outlet. A first set of axial connectors couples the housing to the first shell along a first axis of rotation, and a second set of axial connectors couples the first shell to the second shell along a second axis of rotation, offset from the first axis of rotation by 90 degrees. A first piston is configured to cause the first shell to rotate about the first axis of rotation, and a second piston is configured to cause the second shell to rotate about the second axis of rotation. Actuation of the pistons causes the nozzle outlet to rotate from side-to-side and front-to-back.

### CROSS-REFERENCE TO RELATED APPLICATION(S)

This application claims priority to U.S. Provisional Patent Application No. 63/787,265, filed Apr. 11, 2025, entitled “BLOWER NOZZLE ASSEMBLY AND SYSTEMS AND METHODS THEREOF,” which is incorporated by reference herein, in the entirety and for all purposes.

### TECHNICAL FIELD

The present disclosure relates generally to adjustable blower nozzle assemblies for delivering forced air in multiple directions to a target such as vehicles in a vehicle wash.

### BACKGROUND

In vehicle washes, after a vehicle is washed and rinsed, the vehicle is partially dried to remove water from the wet exterior. In examples, the vehicle may travel underneath a series of air blowers that blow air onto the vehicle to remove water or moisture from the exterior surface of the vehicle. The use of such air blowers may not be sufficient to remove the desired amount of moisture from the exterior surface.

### SUMMARY

Implementations of the present disclosure address the aforementioned drawbacks by providing an adjustable nozzle for delivering forced air in multiple directions to target objects such as vehicles inside of vehicle washes.

According to one implementation, such adjustable nozzles may include a tubular, stationary housing having a spherical first guide surface of enlarged diameter; a first tubular nozzle shell received by the housing, the first shell shaped as a bilaterally truncated sphere, concentrically spaced from the first guide surface, and a second guide surface of enlarged diameter; and a second tubular nozzle shell received by the first shell, the second shell having an upper end with an outer surface shaped as a truncated sphere, concentrically spaced from the second guide surface and a lower end configured as a nozzle outlet. A first set of axial connectors may couple the housing to the first shell along a first axis of rotation. A second set of axial connectors may couple the first shell to the second shell along a second axis of rotation, where the first axis of rotation is offset from the second axis of rotation by 90 degrees. A first piston may be coupled to a rotatable bracket and be configured to cause the first shell to rotate about the first axis of rotation relative to the housing, and during rotation of the first shell, the first shell slaves the second shell in rotation along the first axis of rotation. A second piston may be coupled to the rotatable bracket and to the second shell and be configured to cause the second shell to rotate about the second axis of rotation relative to the first shell.

The housing, the first shell and the second shell may, in some cases, be configured to define a longitudinal axis extending between an air inlet orifice of the housing and the nozzle outlet, and the first axis of rotation and the second axis of rotation may be arranged perpendicular to the longitudinal axis.

The first shell may, in some cases, include a bracket drive process coupled to the rotatable bracket, and the first piston may be coupled to the rotatable bracket such that movement of the first piston causes the rotatable bracket and the first shell to rotate about the first rotational axis back and forth relative to the longitudinal axis L.

The second piston may be coupled to the second shell such that movement of the second piston causes the second shell to rotate relative to the first shell about the second axis and forward and backward relative to the longitudinal axis L.

The housing, the first shell and the second shell, in some cases, may be non-rotatable relative to each other about the longitudinal axis.

The first piston may, in some cases, be configured to cause the first shell to rotate about the first axis of rotation relative to the housing by about -60 degrees to +60 degrees relative to longitudinal axis L.

The second piston may, in some cases, be configured to cause the second shell to rotate about the second axis of rotation relative to the first shell by about -60 degrees to +60 degrees relative to longitudinal axis L.

The housing may include an inlet portion configured to fasten to an outlet of an impeller arranged within the car wash. For instance, the impeller may be supported on a support beam within the car wash.

The nozzle outlet may be configured to rotate side-to-side and front-to-back in response to movement of the first piston and the second piston, and/or may be configured as an unobstructed tubular opening without vanes or other air guides, and/or the nozzle outlet may be tapered (e.g., narrows towards an air egress of the second shell), circular, oval, square, or V-shaped.

The first piston may be coupled to the rotatable bracket at a first end, and a second, opposite end of the first piston may be coupled to a stationary bracket joined to the housing or may be coupled to the housing.

A third piston may optionally couple the rotatable bracket to the second shell and configured to cause the second shell to rotate about the second axis of rotation relative to the first shell.

According to another implementation, an adjustable nozzle for delivering forced air to vehicles inside of vehicle washes may include an air passageway assembly with a tubular, stationary housing having a spherical surface; a first tubular nozzle shell shaped as a bilaterally truncated sphere, concentrically spaced from the housing; and a second tubular nozzle shell having an upper end shaped as a truncated sphere, concentrically spaced from the first shell and a lower end configured as a nozzle outlet. A first set of axial connectors may couple the housing to the first shell along a first axis of rotation, and a second set of axial connectors may couple the first shell to the second shell along a second axis of rotation, and the first axis of rotation may be offset from the second axis of rotation by 90 degrees. A first piston may be coupled to a rotatable bracket and be configured to cause the first shell to rotate about the first axis of rotation relative to the housing, and during rotation of the first shell, the first shell slaves the second shell in rotation along the first axis of rotation. A second piston may couple the rotatable bracket to the second shell and be configured to cause the second shell to rotate about the second axis of rotation relative to the first shell. The air passageway may define a longitudinal axis in a neutral state, and wherein the first axis of rotation and the second axis of rotation are arranged perpendicular to the longitudinal axis.

In yet another embodiment, a method of delivering forced air from an adjustable nozzle, may involve causing forced air to be delivered from an impeller through a nozzle outlet of the adjustable nozzle, in which the adjustable nozzle includes a tubular, stationary housing configured as an air inlet of the adjustable nozzle with a spherical surface for receiving a first tubular nozzle shell shaped as a bilaterally truncated sphere, the first tubular nozzle shell concentrically spaced from the housing and configured for receiving a second tubular nozzle shell having an upper end shaped as a truncated sphere, the second shell concentrically spaced from the first shell and including a lower end configured as the nozzle outlet. The method may involve actuating a first piston coupled to the first shell to cause the first shell to rotate relative to the housing about a first axis of rotation defined by a first set of axial connectors coupling the housing to the first shell, wherein during rotation of the first shell, the forced air is delivered from the nozzle outlet along a first rotational path defined by the first axis of rotation. The method may additionally or alternatively involve actuating a second piston coupled to the second shell to cause the second shell to rotate relative to the first shell about a second axis of rotation defined by a second set of axial connectors coupling the first shell to the second shell, wherein during rotation of the second shell, the force air is delivered from the nozzle outlet along a second rotational path defined by the second axis of rotation, where the first axis of rotation is offset from the second axis of rotation by 90 degrees.

In some cases, the method may further involve determining a vehicle is proximate the adjustable nozzle and causing one of the first piston or the second piston to undergo a plurality of strokes in the actuating thereof to cause the nozzle outlet to move from side-to-side relative to the vehicle, and causing another of the first piston or the second piston to undergo at least one stroke in the actuating thereof to cause the nozzle outlet to move from front-to-back relative to the vehicle.

### BRIEF DESCRIPTION OF THE DRAWINGS

FIG. 1 illustrates the blower nozzle assembly in use, according to the present disclosure.

FIGS. 2A and 2B illustrate isometric views of the blower nozzle assembly according to the present disclosure.

FIGS. 3A and 3B illustrate cross-sectional views of the blower nozzle assembly according to the present disclosure showing the first and second axes of rotation of the blower nozzle assembly in which the blower nozzle assembly of FIG. 3A is rotated by 90 degrees relative to FIG. 3B.

FIGS. 4A and 4B illustrate exploded views of the blower nozzle assembly according to the present disclosure in which the blower nozzle assembly of FIG. 4A is rotated by 90 degrees relative to FIG. 4B.

FIG. 5 illustrates an isometric bottom view of the first nozzle shell, according to the present disclosure.

FIGS. 6A-6D illustrate the blower nozzle assembly in operation, according to the present disclosure.

FIG. 7 is a flow chart of a method of operating the blower nozzle assembly, according to the present disclosure.

FIG. 8 illustrates a simplified block diagram of components of a computing system for operating the blower nozzle assembly according to the present disclosure.

### DETAILED DESCRIPTION

Adjustable blower nozzle assemblies are provided for delivering forced air in multiple directions, which enables a target object, such as a vehicle in a vehicle wash, to be is subjected to drying for a longer period relative to other blowers that delivers forced air one direction. The adjustable blower nozzle may include multiple actuators, such as pneumatically, electrically, or hydraulically driven linear actuators (e.g., pistons), configured to rotate or pivot the blower nozzle assembly in side-to-side movements and in back-and-forth movements, and/or rotary actuators configured to rotate the blower nozzle assembly in rotational movements. Such configurations may enable an object to be dried in multiple directions as the object passes by the adjustable blower nozzle or vice versa. In some cases, a sensor may be employed to determine when the actuator of the blower nozzle assembly 100 should cause a nozzle outlet to rotate or flip to deliver forced air to the object from an opposite direction from which the forced air was initially delivered.

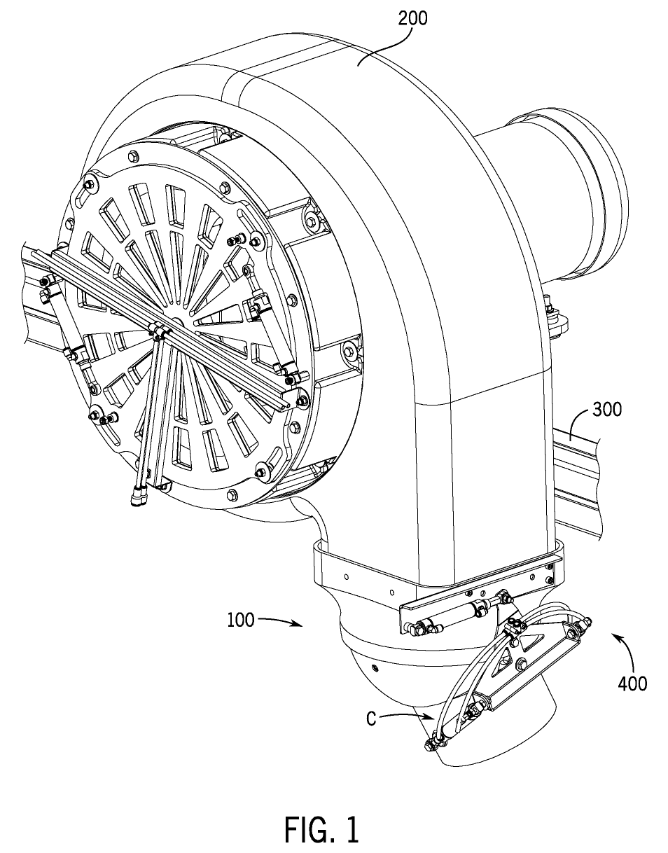

FIG. 1 illustrates the blower nozzle assembly 100 coupled to a blower producer 200 supported by a support arch horizontal beam 300 in a vehicle wash environment 400. As vehicles such as cars and trucks pass through a vehicle wash (e.g., carwash), the vehicles pass underneath support arches affixed to the ground that support equipment like brushes, applicators, or one or more blower nozzle assemblies of the present disclosure. In the case of the blower nozzle assembly 100, air from the blower producer 200, e.g., impeller, is forced through the blower nozzle assembly 100 and is directed towards the vehicle in a front-to-back and side-to-side motion to thereby dry the vehicle as provided herein.

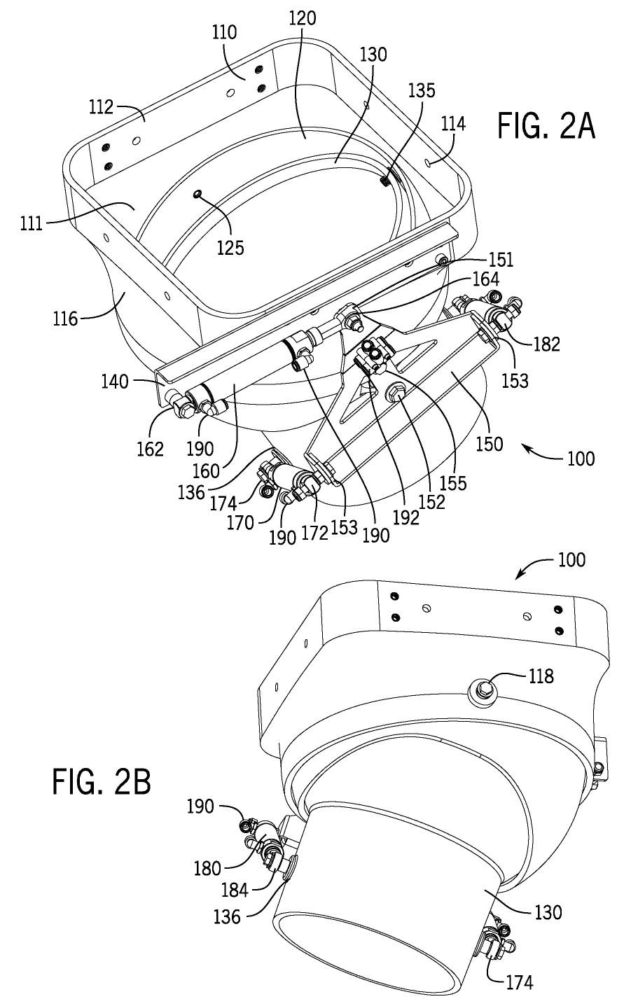

As shown in FIGS. 2A and 2B, the blower nozzle assembly 100 may include a stationary housing 110, a first nozzle shell 120, a first axis of rotation 125, a second nozzle shell 130, a second axis of rotation 135, a stationary bracket 140, a rotatable bracket 150, a first piston 160, a second piston 170, and optionally a third piston 180.

The stationary housing 110 may have a tubular configuration with a spherical guide surface 111 of enlarged diameter. The stationary housing 110 may also include a housing profile 112, couplers 114, a body 116, and first axis of rotation bushings 118.

The housing profile 112 may be configured to be received by the outlet of the blower producer 200 and the housing profile 112 may have any suitable shape such as square, rectangular, round, oval and so on.

The couplers 114 may be configured to couple the stationary housing 110 to the blower producer 200 and the couplers 114 may have any suitable configuration such as openings, threaded openings, fasteners, or combinations thereof.

The body 116 may be configured as the air inlet to the stationary housing 110 as well as the blower nozzle assembly 100, and as an air egress for delivering air to the first nozzle shell 120. The air egress portion of the body 116 may have an inner diameter complementary to an outer diameter of the first nozzle shell 120 and for instance may have a circular or hemispherical shape. The body 116 may be integrally formed with the housing profile 112 and couplers 114, and for instance may be injection molded, rotationally molded, thermoformed, and so on.

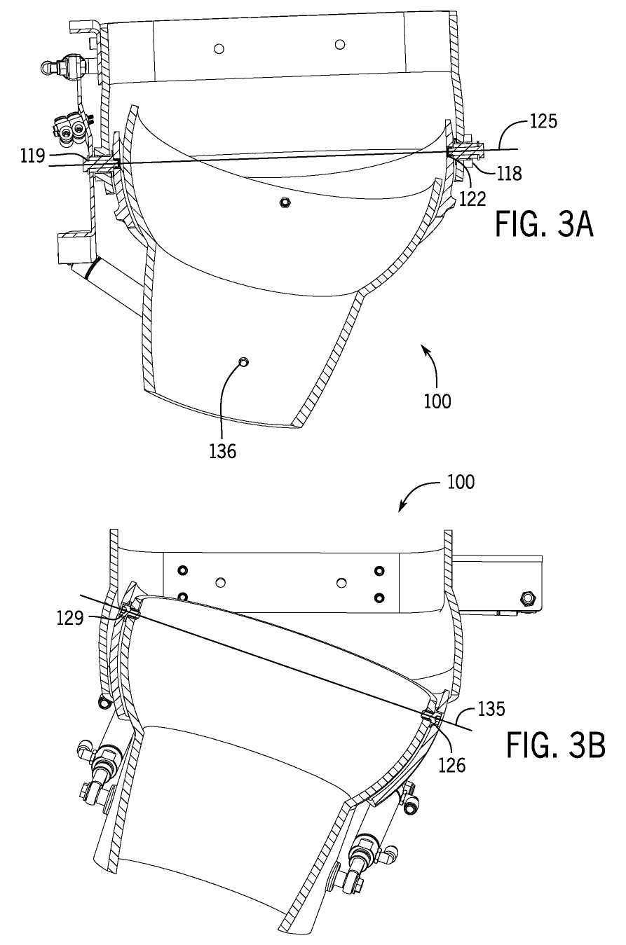

The rotation bushings 118 may be configured for joining the stationary housing 110 to the first nozzle shell 120 so that the stationary housing 110 and the first nozzle shell 120 are rotatable relative to each other along a first axis of rotation 125 (FIG. 3A). The rotation bushings 118 may be configured as through holes arranged on opposite sides of the stationary housing 110 separated by 180 degrees. Axial connectors 119 such as fasteners may be received by the rotation bushings 118 and may couple the stationary housing 110 to the first nozzle shell 120 along the first axis of rotation 125.

In an assembled state, the first nozzle shell 120 may rotate relative to the stationary housing 110 about the first rotational axis 125 defined through the axial connectors 119, and the first nozzle shell 120 may be guided along the guide surface 111 of the stationary housing 110 during such rotation. In some cases, the guide surface 111 is configured as an inner guide surface at an interior of the stationary housing 110 for guiding an external surface of the first nozzle shell 120; while in other cases, the guide surface is configured as an external guide surface at an exterior of the stationary housing 110 for guiding an internal surface of the first nozzle shell 120.

The first nozzle shell 120 may have a tubular shape configured for being received by the stationary housing 110. The first nozzle shell 120 may generally be a bilaterally truncated sphere concentrically spaced from the guide surface 111 of the stationary housing 110 and may define a guide surface 121 of enlarged diameter for guiding the second nozzle shell 130 in rotation. The first nozzle shell 120 may also include an insert 122, a bracket drive process 124, and a second axis of rotation bushing 126.

The insert 122 may extend along the first axis of rotation 125 and be configured for rotationally coupling the first nozzle shell 120 to the stationary housing 110 at the rotational bushings 118.

The bracket drive process 124 may be configured for coupling to the rotatable bracket 150 and may serve as an actuation point for rotation of the first nozzle shell 120 about the first axis of rotation 125 relative to the stationary housing 110 upon actuation of the rotatable bracket 150.

The rotation bushings 126 may be configured as through holes arranged on opposite sides of first nozzle shell 120 separated by 180 degrees and may extend along a second axis of rotation 135 (FIG. 3B). Axial connectors 129 such as fasteners may be received by the rotational bushings 126 and an insert 134 of the second nozzle shell 130 and may couple the first nozzle shell 120 to the second nozzle shell 130 along this second axis of rotation 135.

In the assembled state, the second nozzle shell 130 may rotate relative to the first nozzle shell 120 about the second axis of rotation 135 defined through the rotation bushings 126, and the second axis of rotation 135 may be 90 degrees offset from the first axis of rotation 125. The second nozzle shell 130 may be guided along the guide surface 121 of the first nozzle shell 120 during such rotation. In some cases, the guide surface 121 is configured as an outer guide surface at an exterior of the first nozzle shell 120 for guiding an internal surface of the second nozzle shell 130, while in other cases, the guide surface is configured as an internal guide surface at an interior of the first nozzle shell 120 for guiding an external surface of the second nozzle shell 130.

The second nozzle shell 130 may have a tubular shape with a first end for being received and guided by the first nozzle shell 120. For instance, the first or upper end of the second nozzle shell may be shaped as a truncated sphere concentrically spaced from the inner guide surface 121. A second or lower end of the second nozzle shell 130 may be configured as a nozzle outlet 131 with an air egress 132. The second nozzle shell 130 may also include an insert 134 and a coupler 136.

The second nozzle shell 130, including the nozzle outlet 131, may be configured as an unobstructed tubular opening without vanes or other air guides. In some cases the nozzle outlet 131 may be tapered and may narrow towards the air egress 132 of the second nozzle shell 130. The shape of the outlet 131 may be circular, oval, square, V-shaped, and so on.

The insert 134 may extend along the second axis of rotation 135 and be configured for rotationally coupling the second nozzle shell 130 to the rotational bushings 126 of the first nozzle shell 120.

The coupler 136 may be configured for coupling the second nozzle shell 130 to a piston 170 and may serve as an actuation point for rotation of the second nozzle shell 130 about the second axis of rotation 135 relative to the first nozzle shell 130 upon actuation of the piston 170. The coupler 136 may be arranged at the nozzle outlet 131 portion of the second nozzle shell 130 or at any portion of the second nozzle shell 130 that allows for this shell to rotate about the second axis of rotation 135 relative to the first nozzle shell 120.

The stationary housing 110, the first nozzle shell 120 and the second nozzle shell 130 of the blower nozzle assembly 100 may be configured to define an unobstructed air passageway assembly for directing forced air from the nozzle outlet 131. The blower nozzle assembly 100 may define a longitudinal axis L extending between an air inlet orifice of the housing 110 and the nozzle outlet 131 of the second nozzle shell 130 when the blower nozzle assembly 100 is in a neutral state. In this neutral state, the first axis of rotation 125 and the second axis of rotation 135 may be arranged perpendicular to the longitudinal axis L of the blower nozzle assembly 100, and the axes of rotation 125, 135 may be vertically offset from one another. Due to the couplings at these axes of rotation, the stationary housing 110, the first nozzle shell 120 and the second nozzle shell 130 may be non-rotatable relative to each other around the longitudinal axis L.

The stationary housing 110 and the first and second nozzle shells 120, 130 may be constructed of blown or formed polymeric materials, formed metal, and configured to withstand forces exerted by the air delivered from the blower 200. In some cases, the housing 110, first and second nozzle shells 120, 130 may be constructed of the same materials or their construction may differ from one another.

The stationary bracket 140 of the blower nozzle assembly 100 may be configured to affix the first piston 160 thereto, e.g., via fasteners such as bolts. In some cases the stationary bracket 140 may be affixed to one or more couplers 115 of the stationary housing 110 that are configured for joining to the stationary bracket 140 to the stationary housing 110. For instance, the couplers 115 may be threaded openings or inserts configured for receiving fasteners such as threaded bolts. Accordingly, the stationary housing 110, stationary bracket 140, and one end of the first piston 160 may be non-movable relative to each other.

The rotatable bracket 150 may include a pivot coupler 151, a bracket drive 152, piston end couplers 153, and an axial coupler 155.

The pivot coupler 151 may be configured to join to the first piston rod 160, and the rotatable bracket 150 may be caused to rotate or pivot via the pivot coupler 151 in a driving motion upon actuation of the first piston rod 160.

The bracket drive 152 may be configured to join the rotatable bracket 150 to the first nozzle shell 120 via a fastener (e.g., a bolt and nut).

The piston end couplers 153 may each be configured to join to one end of another piston rod, such as a second piston rod 170 and optionally a third piston rod 180.

The axial coupler 155 may couple the rotatable bracket 150 to the stationary housing 110 at the first axis of rotation 125.

The first piston 160, at a rear pivot 162, may be fixed at one end to the stationary bracket 140 or to the stationary housing 110. At the opposite end of the first piston 160, a piston rod end pivot 164 may be joined to the pivot coupler 151 of the rotatable bracket 150. The first piston 160 may be configured to cause the first shell 120 to rotate about the first axis of rotation 125 relative to the stationary housing 110 due to a driving movement of the first piston 160 slaving the rotatable bracket 150 in movement at the pivot coupler 151, which causes the rotatable bracket 150 to rotate at the axial coupler 155, thereby rotating the bracket drive 152 joined to the first nozzle shell 120 such that the first nozzle shell 120 is rotated relative to the stationary housing 110 about the first axis of rotation 125. For instance, the first piston 160 may cause the first nozzle shell 120 to rotate about the first axis of rotation 125 relative to the housing by about -60 degrees to +60 degrees relative to longitudinal axis L, such as about -20 degrees to +20 degrees relative to longitudinal axis L.

The second piston 170 and optionally a third piston 180 may be fixed at one end to the rotatable bracket 150 and at the opposite end may be joined to the coupler 136 of the second nozzle shell 130. For instance rear pivots 172, 182 may couple the first ends of the pistons 170, 180 to the rotatable bracket 150 via piston end couplers 153 of the rotatable bracket 150. Piston rod end pivots 174, 184 may be joined to couplers 136 on opposite sides of the second nozzle shell 130. The second piston 170 and the optional third piston 180 may be configured to cause the second nozzle shell 130 to rotate about the second axis of rotation 135 relative to the first shell 120. For instance, the piston(s) 170, 180 may be configured to cause the second nozzle shell 130 to rotate about the second axis of rotation 135 relative to the first nozzle shell 120 by about -60 degrees to +60 degrees relative to longitudinal axis L.

The first, second and third pistons 160, 170, 180 may be pneumatically, electrically or hydraulically driven and may include pneumatic or hydraulic ports 190 fluidly coupled to a pneumatic or hydraulic source such as an air or fluid pump via conduits arranged between the pump and the ports 190. Exemplary conduits C are illustrated in FIG. 1 but removed in the remainder of the figures to further illustrate the underlying components of the embodiments of the present disclosure. Tubing organizers 192, referred to as union tees, may also be responsible for fluidly coupling the pistons to the fluid source (e.g., compressed air or fluid) via conduits. The pistons may operate independently of, or in concert with, one another. For instance, the first piston 160 may operate independently of the other pistons 170, 180, while the second piston 170 and the optional third piston 180 may operate in concert with one another. The pistons may operate to cause the nozzle outlet 131 of the blower nozzle assembly 100 to move in multiple directions to follow a passing vehicle. In some cases, one or more of the pistons may be operated pneumatically via an air pump.

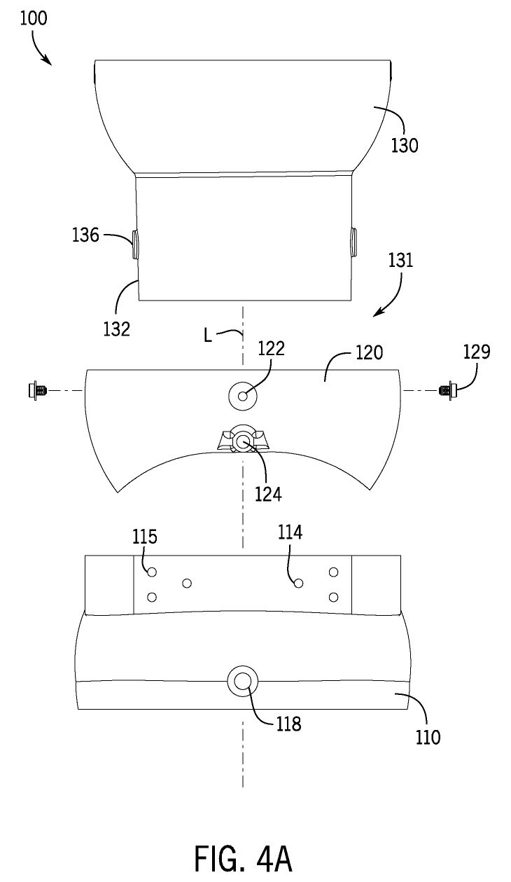

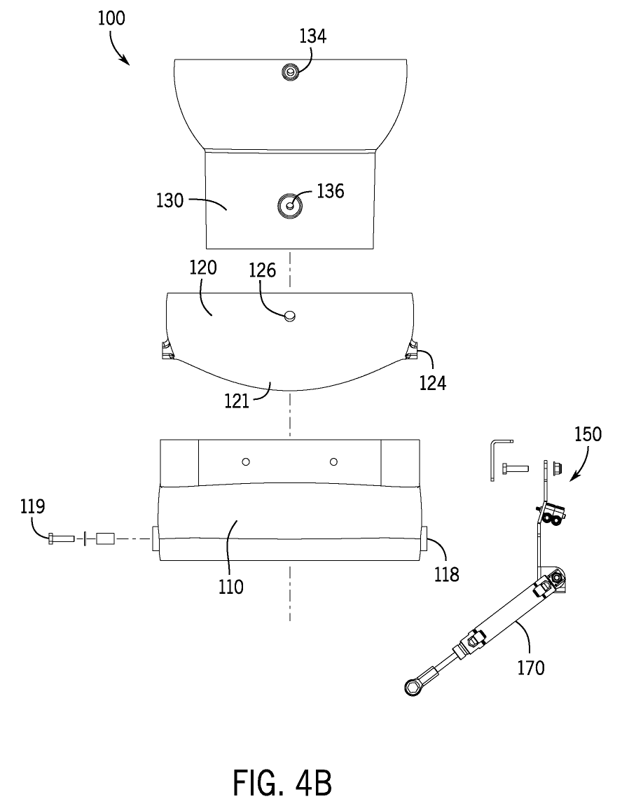

FIG. 4A illustrates an exploded view of the blower nozzle assembly 100 arranged along longitudinal axis L. FIG. 4B illustrates another exploded view of the blower nozzle assembly 100 arranged along the longitudinal axis L in which the blower nozzle assembly 100 of FIG. 4B is rotated by 90 degrees relative to FIG. 4A. When the stationary housing 110, the first nozzle shell 120 and the second nozzle shell 130 are assembled in the air passageway assembly while in the positions shown in FIGS. 4A and 4B, the blower nozzle assembly 100 is in a neutral state and for instance air may be delivered in a direction perpendicular to a ground surface of a vehicle wash.

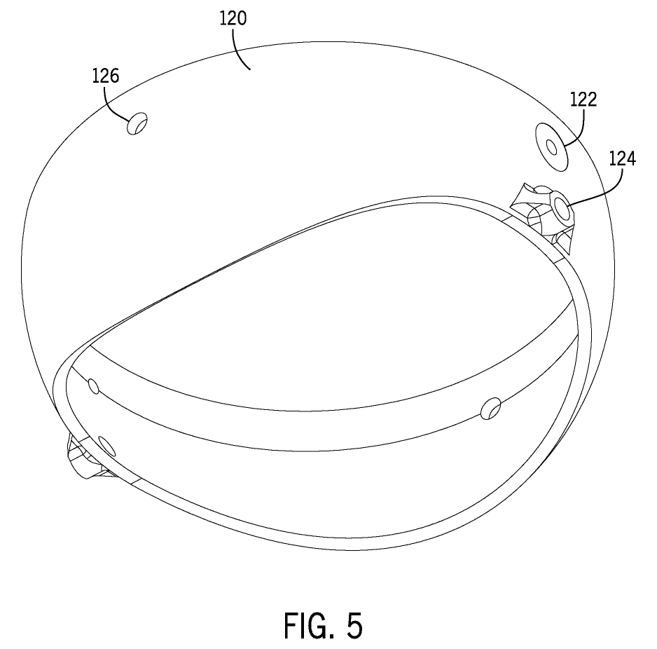

FIG. 5 illustrates an isometric bottom view of the first nozzle shell 120 defining the inserts 122 of the first rotational axis 125 and the rotation bushings 126 of the second rotational axis 135, along with the bracket drive process 124. The sidewall defining the egress of the first nozzle shell 120 in the region of the bracket drive process 124 may be recessed relative to the sidewall of the egress 90 degrees separated therefrom (see FIG. 4A), and this recess may permit rotation of the second nozzle shell 130 relative to the first nozzle shell 120 along the second axis of rotation 135. The external surface of the first nozzle shell 120 may be configured to permit its rotation along the first axis of rotation 125 relative to the stationary housing 110.

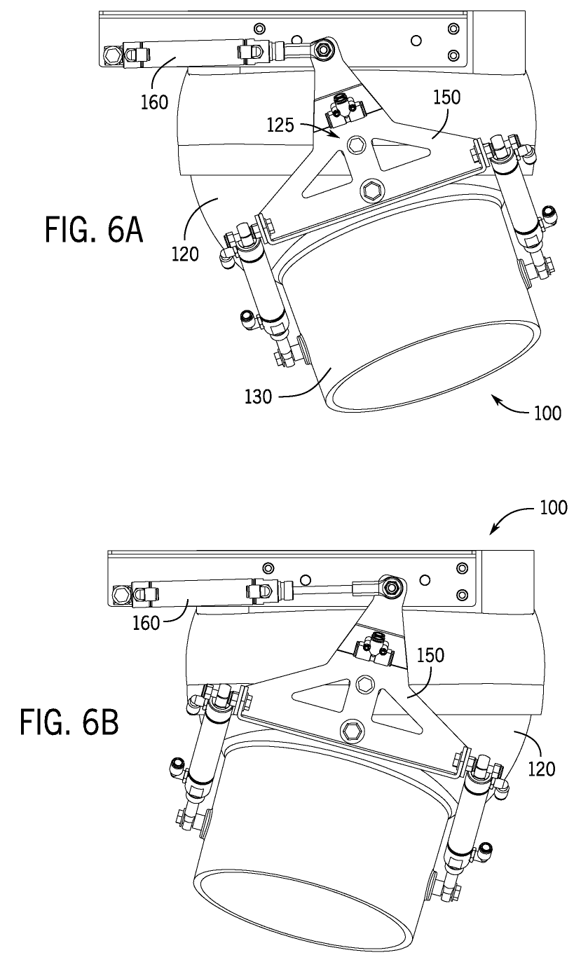

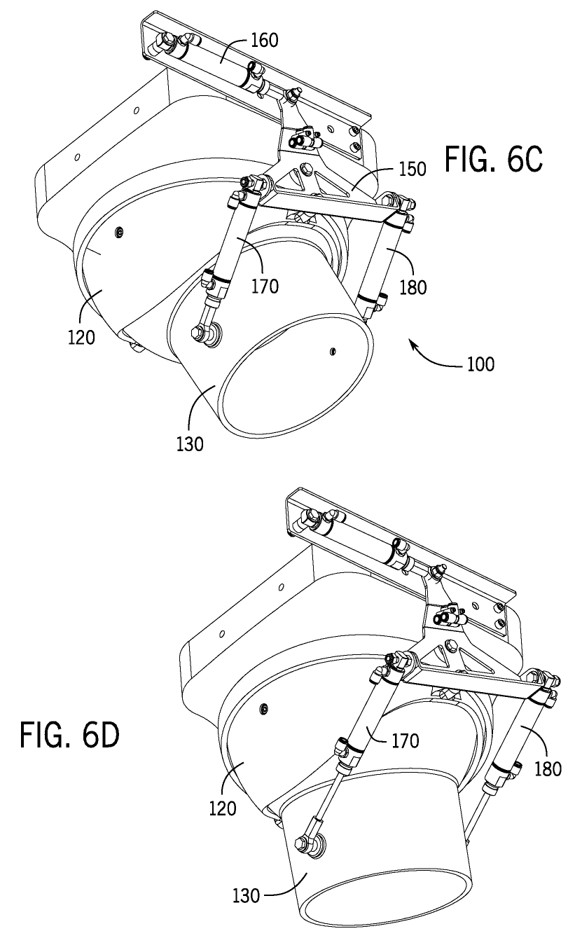

Turning to FIGS. 6A-6D, illustrated are views of the blower nozzle assembly 100 in operation. FIGS. 6A-6B illustrate rotation of the fist nozzle shell 120 about the first axis of rotation 125 in response to actuation of the first piston 160 through a pivot stroke. The first axis of rotation 125 may also be referred to as a top axis of rotation, which rotation of the first shell 120 occurs within nested spherical portions defined by the stationary housing 110 and the first shell 120. FIG. 6A illustrates the first piston 160 in a first position in which the first nozzle shell 120 is rotated in a first rotational position, while FIG. 6B illustrates the first piston 160 in a second position in which the first nozzle shell 120 is rotated in a second rotational position. The rotational path between the first and second rotational positions may be about -60 degrees to +60 degrees relative to longitudinal axis L, which may be the maximum rotational path of the first nozzle shell 120 along the first axis of rotation 125. During such rotation, the first nozzle shell 120 slaves the second nozzle shell 130 in rotation from the first to the second rotational positions as also shown in FIGS. 6A and 6B.

FIGS. 6C and 6D illustrate rotation of the second nozzle shell 130 about the second axis of rotation 135 in response to actuation of the second and third pistons 170, 180 through a pivot stroke. The second axis of rotation 135 may also be referred to as a bottom axis of rotation, which rotation of the second shell 130 occurs within nested spherical portions of the first shell 120 and the second shell 130. FIG. 6C illustrates the pistons 170, 180 in a first position in which the second nozzle shell 130 is rotated in a third rotational position, while FIG. 6D illustrates the pistons 170, 180 in a second position in which the second nozzle shell 130 is rotated in a fourth rotational position. The rotational path between the third and the fourth rotational positions may be about -60 degrees to +60 degrees relative to longitudinal axis L or -24 degrees to +24 degrees relative to the longitudinal axis L, which may be the maximum rotational path of the second nozzle shell along the second axis of rotation 135. Accordingly, the second nozzle shell 130 is rotatable in multiple directions along both the first and second axes of rotation 125, 135 to deliver forced air to a target moving relative to the blower nozzle assembly 100 for a longer period of time and in more angular positions compared to prior approaches.

In alternative embodiments, one or more of the axes of rotation may be driven by a rotary actuator (e.g., electric, pneumatic, or hydraulic) rather than a linear actuator (e.g., piston 160 and/or piston 170). In such cases, the first or second nozzle shell 120, 130 may be rotatable about the longitudinal axis L by a rotary actuator rather than relative to a respective first or second axes of rotation 125, 135 to deliver forced air to a target. In one example, the second nozzle shell 130 may be driven by a rotary actuator rather than piston 170 and optional piston 180, while the first nozzle shell 120 may be driven linearly by piston 160.

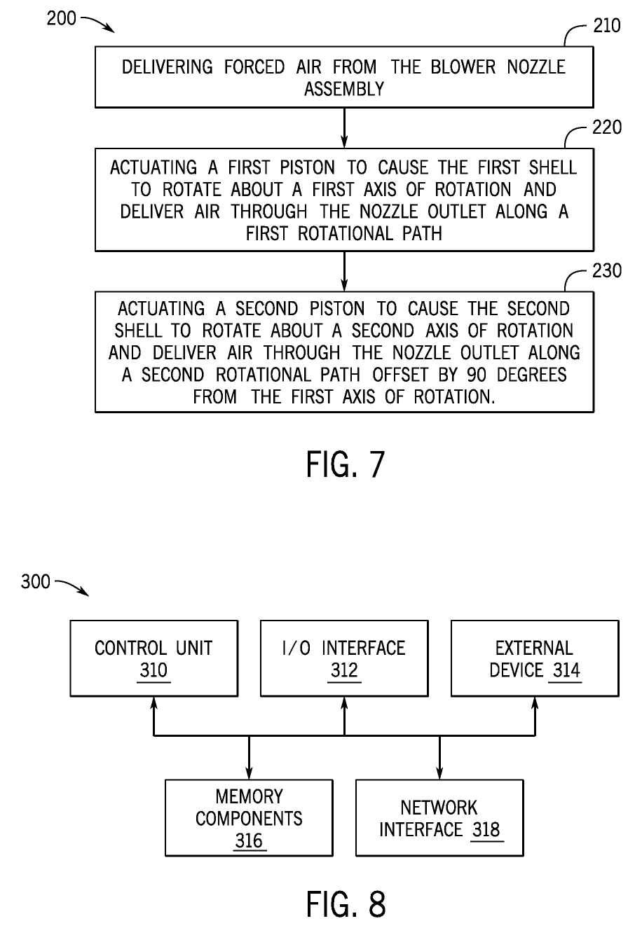

Turning to FIG. 7, illustrated is a flow chart of a method 200 of operating the blower nozzle assembly 100. The method 200 involves, in step 210, delivering forced air from the blower nozzle assembly 100 by causing forced air to be delivered from an impeller into an inlet defined by the housing 110, through the adjustable nozzle 100 and out of the nozzle outlet 131, e.g., as provided hereinabove. In step 220, the method 200 may proceed by actuating (e.g., pneumatically) the first piston 160 coupled to the first shell 120 of the adjustable nozzle 100 to cause the first shell 120 to rotate relative to the housing 110 about a first axis of rotation 125 such that the forced air is delivered from the nozzle outlet 131 along a first rotational path defined by the first axis of rotation 125. In step 230, the method 200 may involve actuating (e.g., pneumatically) the second piston 170 coupled to the second shell 130 to cause the second shell 130 to rotate relative to the first shell 120 about the second axis of rotation 135 such that the forced air is delivered from the nozzle outlet 131 along a second rotational path defined by the second axis of rotation 135, which is offset from the first axis of rotation by 90 degrees as provided herein. The method 200 may be implemented using a control unit 310 of a computing system 300 (FIG. 8) communicatively coupled to a power source of the blower nozzle assembly 100, such as a pneumatic pump, and to the blower 200.

According to certain implementations, the piston responsible for side-to-side movement may operate continuously, e.g., via multiple strokes of the piston, while a vehicle is present in an area proximate the blower nozzle assembly 100; and another piston responsible for back-and-forth movement may operate in a single stroke after a first or front portion of the vehicle passes under the blower such that the nozzle outlet 131 rotates or flips causing the air to be directed in an opposite direction and towards the back of the vehicle as it exits the wash such that the vehicle continues to receive the forced air. The blower nozzle assembly 100 may therefore be adjustable to increase the amount of time the vehicle is subjected to drying by delivering forced air in multiple directions. This adjustability provides advantages over a blower with a nozzle that only delivers forced air in one direction, or only delivers air in a side-to-side movement.

In some cases, a sensor, such as a photo eye may be employed to determine when the pistons should operate. For instance, the sensor may be used by the control unit 310 to control when the pistons of the blower nozzle assembly 100 should be actuated and when the blower 200 should be operated. For instance, the control unit 310 may cause one or more pistons to actuate to move the nozzle outlet 131 from side-to-side relative to a target object or vehicle and may cause one or more other pistons to actuate to cause the nozzle outlet 131 to rotate or flip to deliver forced air to the vehicle as it exits the vehicle wash. In addition or alternatively, the piston responsible for back-and-forth movement may operate in multiple strokes for a period of time until the vehicle has advanced sufficiently through the wash, in which case, the piston may undergo final stroke so that the forced air is delivered to the back of the vehicle as it exits. The pistons may then reset and/or be idle until a next vehicle passes by the blower nozzle assembly 100.

FIG. 8 illustrates a simplified block diagram of components of a computing system 300 for operating the blower nozzle assembly 100 according to the present disclosure. The computing system 300 may include the control unit 310 and its one or more processors and associated memory, input/output (I/O) interface 312 such as a user interface, one or more external devices 314 such as power sources coupled to actuators including the pistons 160, 170, 180 and one or more blowers 200, one or more memory components 316, and a network interface 318. The various components may be in communication with one another through one or more buses or communication networks, such as wired or wireless networks. The components in FIG. 8 are exemplary only. In various examples, the computing system 300 may include additional components and/or functionality not shown in FIG. 8.

The control unit 310 may be any type of electronic device capable of processing, receiving, and/or transmitting instructions. For example, the control unit 310 may be configured as a central processing unit, microprocessor, processor, or microcontroller.

The I/O interface 312 allows a user to enter data in to computing system 300, as well as provides an input/output for the computing system 300 to communicate with other devices or services. The I/O interface 312 can include one or more input buttons, touch pads, touch screens, and so on.

The external device 314 may be one or more devices used to provide various inputs to the computing system 300, e.g., sensors (photo eyes) or feedback systems, and/or that may receive outputs from the computing system 300, e.g. mechanical and/or electrical components such as power sources (e.g., pneumatic pumps) coupled to actuators including the pistons 160, 170, 180 of the blower nozzle assembly 100 and one or more blowers 200. The external devices 314 may be local or remote and may vary as desired.

The memory components 316 are used by the computing system 300 to store instructions for the control units 310 such as an application and/or user interface, as well as store data, such as the databases provided herein, the nozzle assembly operation information, user preferences, alerts, etc. The memory components 316 may be, for example, magneto-optical storage, read-only memory, random access memory, erasable programmable memory, flash memory, or a combination of one or more types of memory components. The memory components 316 may be integrated into the control units 310.

The network interface 318 provides communication to and from the computing system 300 to other devices. The network interface 318 may be communicatively coupled to a gateway located at the vehicle wash or location housing the blower nozzle assembly 100 or may be provided as a network gateway for communicating with other network components. The network interface 318 may be communicatively coupled to a car wash controller housed at the vehicle wash location. In some cases, the network interface 318 may be the sole communicative coupling between the control unit 310 and the car wash controller. The network interface 318 includes one or more communication protocols, such as, but not limited to Wi-Fi, Ethernet, Bluetooth, etc. The network interface 318 may also include one or more hardwired components, such as a Universal Serial Bus (USB) cable, or the like. The configuration of the network interface 318 depends on the types of communication desired and may be modified to communicate via Wi-Fi, Bluetooth, etc.

Various changes may be made in the form, construction and arrangement of the components of the present disclosure without departing from the disclosed subject matter or

without sacrificing all of its material advantages. The form described is merely explanatory, and it is the intention of the following claims to encompass and include such changes. Moreover, while the present disclosure has been described with reference to various embodiments and implementations, it will be understood that these embodiments are illustrative and that the scope of the disclosure is not limited to them. Many variations, modifications, additions, and improvements are possible. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. An adjustable nozzle for delivering forced air to vehicles inside of a vehicle wash, comprising:
a tubular, stationary housing having a spherical first guide surface of enlarged diameter;
a first tubular nozzle shell received by the housing, the first shell shaped as a bilaterally truncated sphere, concentrically spaced from the first guide surface, and a second guide surface of enlarged diameter;
a second tubular nozzle shell received by the first shell, the second shell having an upper end with an outer surface shaped as a truncated sphere, concentrically spaced from the second guide surface and a lower end configured as a nozzle outlet;
a first set of axial connectors coupling the housing to the first shell along a first axis of rotation;
a second set of axial connectors coupling the first shell to the second shell along a second axis of rotation, wherein the first axis of rotation is offset from the second axis of rotation by 90 degrees;
a first piston coupled to a rotatable bracket and configured to cause the first shell to rotate about the first axis of rotation relative to the housing, wherein during rotation of the first shell, the first shell slaves the second shell in rotation along the first axis of rotation; and
a second piston coupling the rotatable bracket to the second shell and configured to cause the second shell to rotate about the second axis of rotation relative to the first shell.

2. The adjustable nozzle according to claim 1, wherein the housing, the first shell and the second shell are configured to define a longitudinal axis extending between an air inlet orifice of the housing and the nozzle outlet, wherein the first axis of rotation and the second axis of rotation are arranged perpendicular to the longitudinal axis.

3. The adjustable nozzle according to claim 2, wherein the first shell comprises a bracket drive process coupled to the rotatable bracket, and wherein the first piston is coupled to the rotatable bracket such that movement of the first piston causes the rotatable bracket and the first shell to rotate about the first rotational axis back and forth relative to the longitudinal axis.

4. The adjustable nozzle according to claim 2, wherein the second piston is coupled to the second shell such that movement of the second piston causes the second shell to rotate relative to the first shell about the second axis and forward and backward relative to the longitudinal axis.

5. The adjustable nozzle according to claim 2, wherein the housing, the first shell and the second shell are non-rotatable relative to each other about the longitudinal axis.

6. The adjustable nozzle according to claim 2, wherein the first piston is configured to cause the first shell to rotate about the first axis of rotation relative to the housing by about -60 degrees to +60 degrees relative to the longitudinal axis.

7. The adjustable nozzle according to claim 1, wherein the second piston is configured to cause the second shell to rotate about the second axis of rotation relative to the first shell by about -60 degrees to +60 degrees relative to a longitudinal axis.

8. The adjustable nozzle according to claim 1, wherein the housing comprises an inlet portion configured to fasten to an outlet of an impeller arranged within the vehicle wash.

9. The adjustable nozzle according to claim 8, wherein the impeller is supported on a support beam within the vehicle wash.

10. The adjustable nozzle according to claim 1, wherein the nozzle outlet is configured to rotate side-to-side and front-to-back in response to movement of the first piston and the second piston.

11. The adjustable nozzle according to claim 1, wherein the nozzle outlet is configured as an unobstructed tubular opening without vanes or other air guides.

12. The adjustable nozzle according to claim 1, wherein the nozzle outlet has a shape that is at least one of tapered, circular, oval, square, or V-shaped.

13. The adjustable nozzle according to claim 1, wherein the first piston is coupled to the rotatable bracket at a first end, and a second, opposite end of the first piston is coupled to a stationary bracket joined to the housing or is coupled to the housing.

14. The adjustable nozzle according to claim 1, further comprising a third piston coupling the rotatable bracket to the second shell and configured to cause the second shell to rotate about the second axis of rotation relative to the first shell.

15. An adjustable nozzle for delivering forced air to vehicles inside of a vehicle wash, comprising:
an air passageway assembly comprising:
a tubular, stationary housing having a spherical surface;
a first tubular nozzle shell shaped as a bilaterally truncated sphere, the first shell concentrically spaced from the housing;
a second tubular nozzle shell having an upper end shaped as a truncated sphere, the second shell concentrically spaced from the first shell and a lower end configured as a nozzle outlet;
a first set of axial connectors coupling the housing to the first shell along a first axis of rotation;
a second set of axial connectors coupling the first shell to the second shell along a second axis of rotation, wherein the first axis of rotation is offset from the second axis of rotation by 90 degrees;
a first piston coupled to a rotatable bracket and configured to cause the first shell to rotate about the first axis of rotation relative to the housing, wherein during rotation of the first shell, the first shell slaves the second shell in rotation along the first axis of rotation; and
a second piston coupling the rotatable bracket to the second shell and configured to cause the second shell to rotate about the second axis of rotation relative to the first shell,
wherein the air passageway defines a longitudinal axis in a neutral state, and wherein the first axis of rotation and the second axis of rotation are arranged perpendicular to the longitudinal axis.

16. The adjustable nozzle according to claim 15, wherein the first shell comprises a bracket drive process coupled to the rotatable bracket, and wherein the first piston is coupled to the rotatable bracket such that movement of the first piston causes the rotatable bracket and the first shell to rotate about the first rotational axis relative to the longitudinal axis.

17. The adjustable nozzle according to claim 16, wherein the second piston is coupled to the second shell such that movement of the second piston causes the second shell to rotate relative to the first shell about the second rotational axis relative to the longitudinal axis.

18. A method of delivering forced air from an adjustable nozzle, comprising:
causing forced air to be delivered from an impeller through a nozzle outlet of the adjustable nozzle, wherein the adjustable nozzle comprises a tubular, stationary housing configured as an air inlet of the adjustable nozzle with a spherical surface for receiving a first tubular nozzle shell shaped as a bilaterally truncated sphere, the first shell concentrically spaced from the housing and configured for receiving a second tubular nozzle shell having an upper end shaped as a truncated sphere, the second shell concentrically spaced from the first shell and including a lower end configured as the nozzle outlet;
actuating a first piston coupled to the first shell to cause the first shell to rotate relative to the housing about a first axis of rotation defined by a first set of axial connectors coupling the housing to the first shell, wherein during rotation of the first shell, the forced air is delivered from the nozzle outlet along a first rotational path defined by the first axis of rotation; and
actuating a second piston coupled to the second shell to cause the second shell to rotate relative to the first shell about a second axis of rotation defined by a second set of axial connectors coupling the first shell to the second shell, wherein during rotation of the second shell, the force air is delivered from the nozzle outlet along a second rotational path defined by the second axis of rotation,
wherein the first axis of rotation is offset from the second axis of rotation by 90 degrees.

19. The method of claim 18, further comprising using a control unit to determine a vehicle is proximate the adjustable nozzle; causing one of the first piston or the second piston to undergo a plurality of strokes in the actuating thereof to cause the nozzle outlet to move from side-to-side relative to the vehicle; and causing another of the first piston or the second piston to undergo at
least one stroke in the actuating thereof to cause the nozzle outlet to move from front-to-back relative to the vehicle.
